(19) United States
(12) Patent Application Publication
(10) Pub. No.: US 2005/0011920 A1
(43) Pub. Date: Jan. 20, 2005

(54) Carrying case and display device combination for vehicle

(76) Inventor: Chi Feng Feng, Taichung (TW)

Correspondence Address: Chi Feng FENG, P.O. Box 63-99, Taichung, 406, TW

(21) Appl. No.: 10/622,814

(22) Filed: Jul. 17, 2003

(51) Int. Cl. B60R 7/00

(52) U.S. Cl. 224/275; 224/929

(57) ABSTRACT

A device for a vehicle includes a carrying case having a housing and a casing each of which includes a chamber for receiving objects or the electric facilities. The casing includes one or more fastening bands attached to the upper portion, and/or one or more fastening bands attached to either of the side portions, and/or one or more fastening bands attached to the lower portion, for solidly attaching the carrying case and the electric facility to the headrest of the vehicle, and for prevent the portable electric facilities from moving or vibrating or rocking or swinging relative to the vehicle.

### BACKGROUND OF THE INVENTION

1. Field of the Invention

The present invention relates to a carrying case or an electric display device, and more particularly to a carrying case and display device combination for solidly attaching to vehicle, such as the headrest of the vehicle.

2. Description of the Prior Art

Various kinds of portable electric facilities, such as portable or notebook computers, video compact discs (VCD), digital video discs (DVD), or other display or monitor devices, have been developed and to be carried with and used by users everywhere.

For allowing the portable electric facilities to be attached onto and used in vehicles, various kinds of typical carrying case have been developed to carry the portable electric facilities therein, and to attach the portable electric facilities onto the seat back of the vehicle, and thus for allowing the users to use or operate the portable electric facilities in the vehicles.

For example, U.S. Pat. No. 6,092,705 to Meritt discloses a self-contained case for housing transporting and mounting video monitor and video player for use in passenger vehicles, and comprises a principle case loosely attached to the seat back of the vehicle with a quick connect strap device.

However, the principle case may only be loosely attached to the seat back of the vehicle with the quick connect strap device, and may be dependent downwardly or supported below the headrest of the vehicle; i.e., supported below the head or shoulder of the passengers in the back seats of the vehicle, such that the passengers in the back seats of the vehicle should look downwardly toward the portable electric facilities. The passengers may become fatigue easily and quickly after viewing the portable electric facilities a short period of time.

In addition, the principle case may only be loosely attached to the seat back of the vehicle and may easily swing or vibrate or rock while the vehicle is moving, such that the passengers may not clearly view or watch the portable electric facilities, and such that the passengers may further become fatigue easily and quickly after viewing the portable electric facilities a short period of time.

The present invention has arisen to mitigate and/or obviate the afore-described disadvantages of the conventional carrying case and display device combinations.

### SUMMARY OF THE INVENTION

The primary objective of the present invention is to provide a carrying case and display device combination for solidly attaching the portable electric facilities to vehicle, such as the headrest of the vehicle, and for prevent the portable electric facilities from moving or vibrating or rocking or swinging relative to the vehicle.

In accordance with one aspect of the invention, there is provided a combination for attaching to a headrest of a vehicle, the combination comprising a carrying case including a housing and a casing each having a side portion secured together, and each having two side portions and an upper portion openably secured together with a fastening device. The housing and the casing each includes a chamber formed in an inner portion thereof for receiving objects, and each includes an outer portion superposable with each other, an electric facility receivable in the chamber of the housing. The casing includes at least one first fastening band attached to the upper portion thereof, and at least one second fastening band attached to either of the side portions thereof, for engaging onto the headrest of the vehicle, and for solidly attaching and retaining the carrying case and the electric facility to the headrest of the vehicle, and for suitably elevating the portable electric facilities to the headrest or above the back seat, and for prevent the portable electric facilities from moving or vibrating or rocking or swinging relative to the vehicle.

The housing includes a pocket provided in the lower portion thereof to define a space therein, and to receive a lower portion of the electric facility. The housing further includes a resilient fastening belt attached to the upper portion thereof, to resiliently clamp an upper portion of the electric facility, and to retain the electric facility in the chamber of the housing.

Each of the first and the second fastening bands includes a hook and loop fastening device attached to a free end portion thereof for fastening the carrying case to the headrest of the vehicle. The casing includes a compartment attached to the outer portion thereof for receiving objects therein.

The casing includes at least one third fastening band attached to the lower portion thereof, and engageable with the first fastening band thereof, to attach the carrying case to the headrest of the vehicle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a rear perspective view illustrating an attachment of a carrying case and display device combination in accordance with the present invention onto a headrest of a vehicle;

FIG. 2 is a front perspective view illustrating the attachment of the carrying case and display device combination onto the headrest of the vehicle;

FIG. 3 is a partial exploded view illustrating the attachment of the carrying case and display device combination onto the headrest of the vehicle;

FIG. 4 is a perspective view of the carrying case and display device combination in accordance with the present invention, which is in an enclosed position of configuration;

FIG. 5 is a perspective view of the carrying case and display device combination, similar to FIG. 4, which is in an open position of configuration;

FIG. 6 is a perspective view of the carrying case and display device combination, similar to FIG. 5, illustrating the operation of the carrying case and display device combination; and

FIG. 7 is a perspective view of the carrying case and display device combination, similar to FIG. 6, illustrating the operation of the carrying case and display device combination for attaching other portable electric facilities to the head seat of the vehicle.

### DETAILED DESCRIPTION OF THE PREFERRED EMBODIMENT

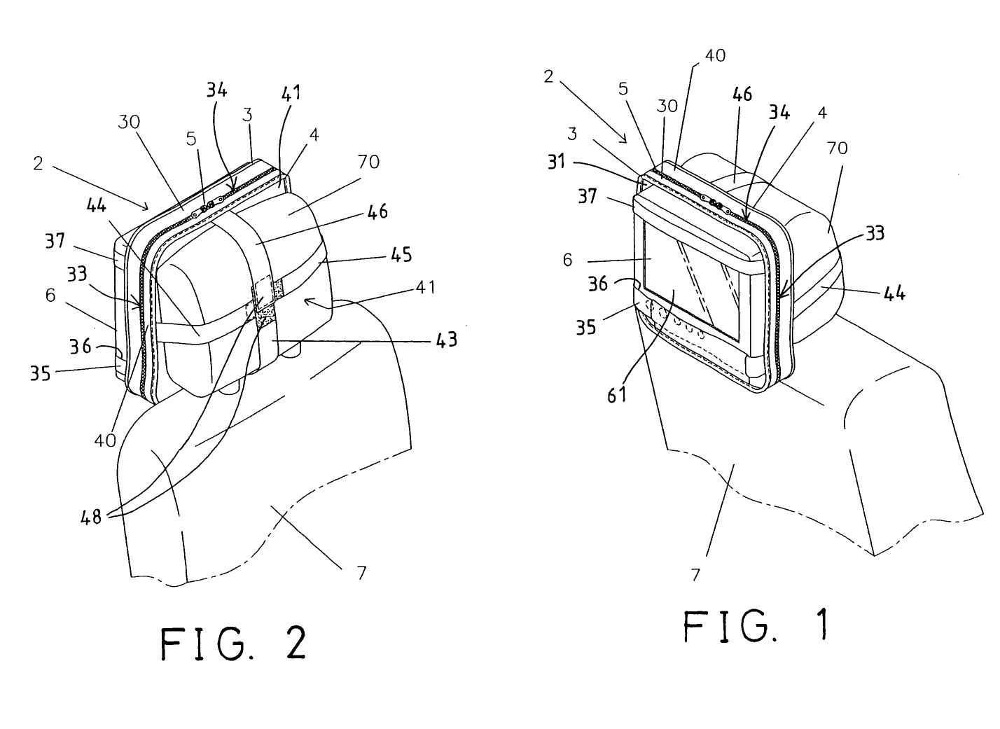

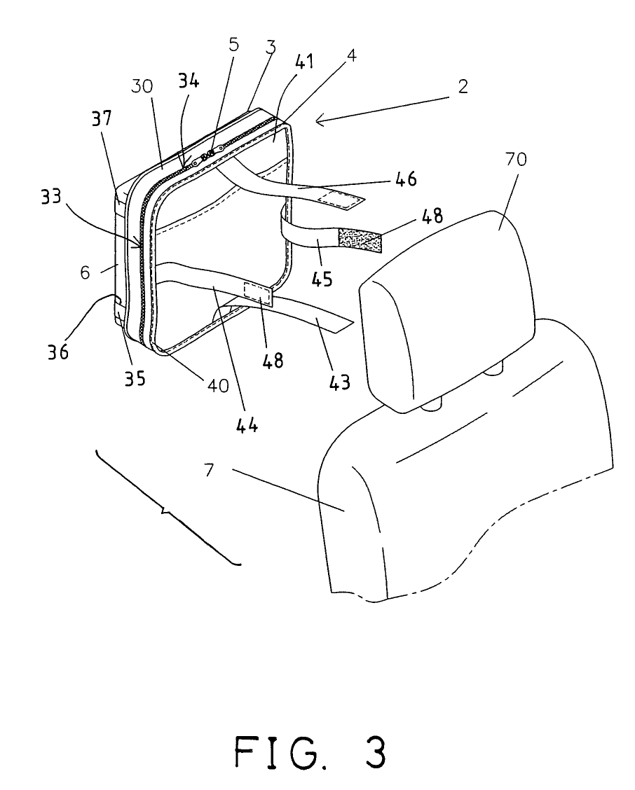

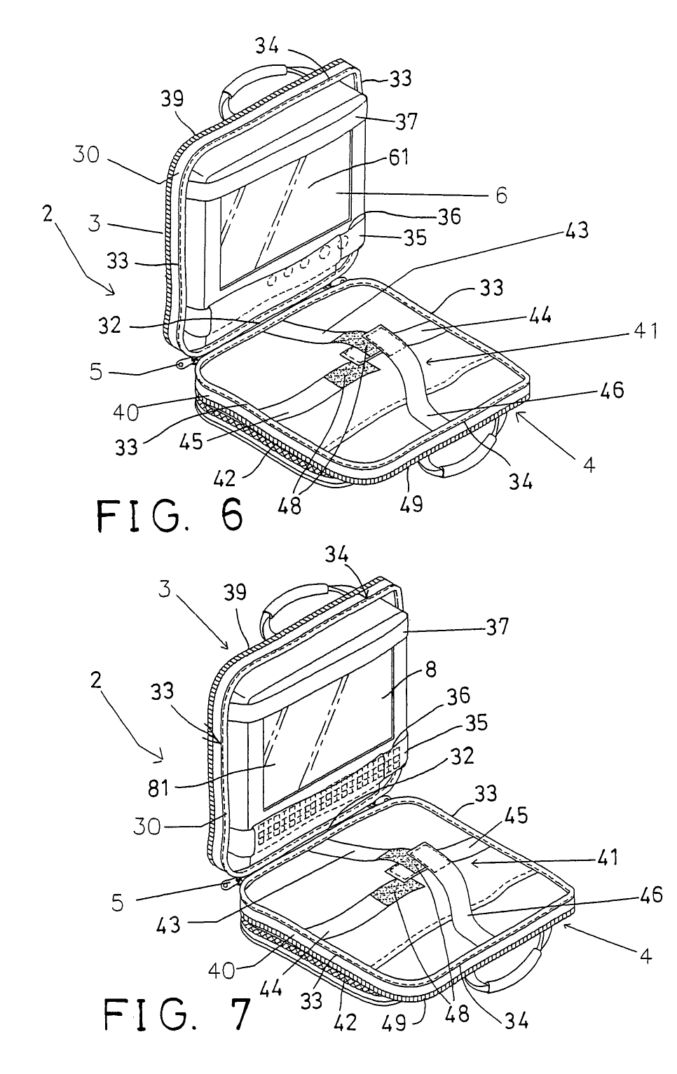

Referring to the drawings, and initially to FIGS. 1-6, a carrying case and display device combination in accordance with the present invention comprises a carrying case 2 for receiving and attaching a portable electric facility 6, 8, such as digital video disc (FIGS. 1-3 and 6), portable computer 8 (FIG. 7), video compact disc, or other display or monitor devices, to a vehicle, such as to a headrest 70 of a seat back 7 of a vehicle.

The carrying case 2 includes a housing 3 and a casing 4 each having an outer peripheral wall 30 provided or extended thereon to form or define a chamber 31, 41 in the inner portion thereof, for receiving various objects therein, such as the portable electric facilities 6, 8 therein. The housing 3 and the casing 4 include a lower portion 32 pivotally secured together, for allowing the housing 3 and the casing 4 to be opened relative to each other.

The housing 3 and the casing 4 include two side portions 33 and an upper portion 34 openably secured together with a fastening device 5, such as a zipper 5, for enclosing and retaining the objects and/or the portable electric facilities 6, 8 within the chambers 31, 41 of the housing 3 and the casing 4.

The housing 3 and the casing 4 may also be folded inside-out, to superpose the outer portions 39, 49 of the housing 3 and the casing 4 with each other, and to be openably secured together with the fastening device 5 (FIGS. 1-3). The inner chambers 31, 41 of the housing 3 and the casing 4, or the objects or the portable electric facilities 6, 8 received within the chambers 31, 41 of the housing 3 and the casing 4 may thus be exposed when the outer portions 39, 49 of the housing 3 and the casing 4 are superposed with each other.

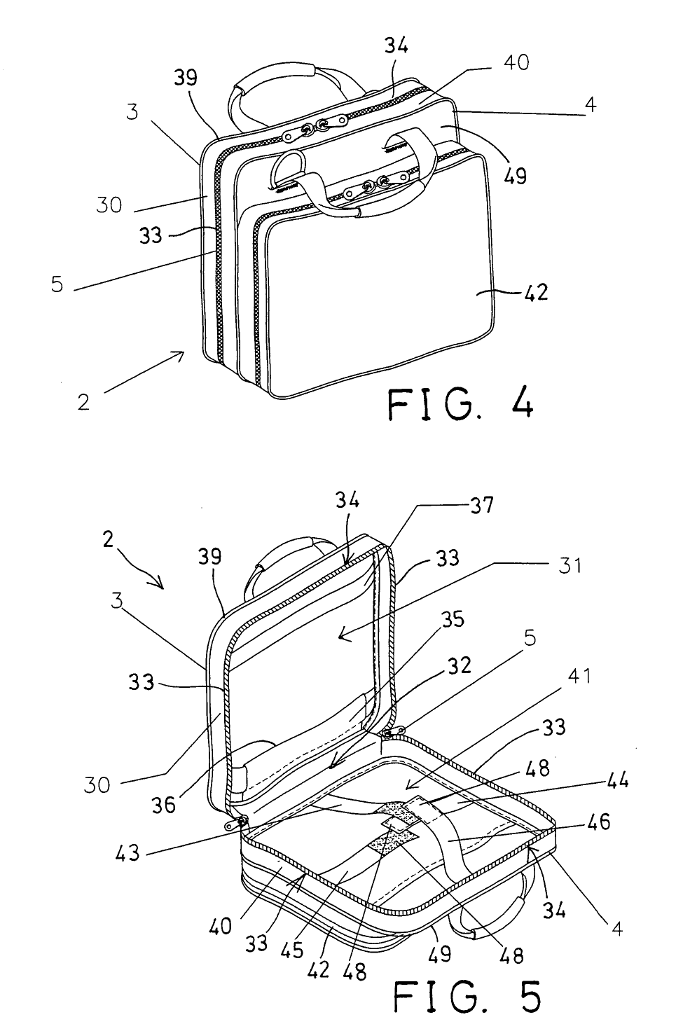

The casing 4 may further include a pocket or a compartment 42 (FIGS. 4-7) provided or attached to the front or outer portion 49 thereof, for receiving other objects or peripheral facilities (not shown) of the portable electric facilities 6, 8. The compartment 42 of the casing 4 may be enclosed or received between the housing 3 and the casing 4 when the housing 3 and the casing 4 are secured together back-to-back.

The housing 3 includes a strap or a pocket 35 provided or formed in the lower portion 32 thereof, to form or define a space 36 therein, and to receive a lower portion of the portable electric facility 6 (FIGS. 1-3 and 6) or 8 (FIG. 7), and a resilient or fastening belt 37 attached to the upper portion 34 thereof, to resiliently clamping the upper portion of the portable electric facility 6 or 8, and to retain the portable electric facility 6 or 8 within the chamber 31 of the housing 3.

As best shown in FIGS. 1, 6, 7, each of the portable electric facilities 6, 8 includes a screen 61, 81 arranged between the pocket 35 and the fastening belt 37, for allowing the screen 61, 81 to be easily seen through the space or area formed or defined between the pocket 35 and the fastening belt 37, and for preventing the screen 61, 81 from being obstructed by the pocket 35 and the fastening belt 37.

As shown in FIGS. 2-3 and 5-7, the casing 4 includes one or more fastening bands 43 attached to or secured to or extended from the lower portion 32 thereof, and/or one or more fastening bands 44, 45 attached to or secured to or extended from each of the side portions 33 thereof, and/or one or more fastening bands 46 attached to or secured to or extended from the upper portion 34 thereof. The fastening bands 43, 46 may be formed or secured together as a one-integral fastening band, and the other fastening bands 44, 45 may also be formed or secured together as a one-integral fastening band, in order to form a cross-shape fastening configuration (FIG. 2).

Each of the fastening bands 43-46 includes a fastening member 48, such as a hook and loop device 48 attached to the free end portion thereof and engageable with each other, to detachably or solidly attached the carrying case 2 to the headrest 70 of the seat back 7. It is to be noted that two of the fastening bands 43-46, such as the fastening bands 45-46, are good enough to solidly attached the carrying case 2 to the headrest 70 of the seat back 7, with such as the cross-shape fastening configuration (FIG. 2).

In operation, as shown in FIGS. 1-3, the carrying case 2 and thus the portable electric facilities 6, 8 may be solidly attached to the headrest 70 of the seat back 7 with the fastening bands 43-46, and may be prevented from moving or vibrating or rocking or swinging relative to the vehicle, for allowing the users to easily viewing or watching the portable electric facilities 6, 8.

In addition, the headrest 70 of the vehicle is located above or higher than the seat back 7 of the vehicle, and the carrying case 2 and thus the portable electric facilities 6, 8 may be solidly attached to the headrest 70 of the vehicle, such that users may easily view or watch the portable electric facilities 6, 8 without heading downwardly.

Accordingly, the carrying case and display device combination in accordance with the present invention may be used for solidly attaching the portable electric facilities to vehicle, such as the headrest of the vehicle, and for prevent the portable electric facilities from moving or vibrating or rocking or swinging relative to the vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A combination for attaching to a headrest of a vehicle, said combination comprising:
a carrying case including a housing and a casing each having a side portion secured together, and each having two side portions and an upper portion openably secured together with a fastening device,
said housing and said casing each including a chamber formed in an inner portion thereof for receiving objects, and each including an outer portion superposable with each other,
an electric facility receivable in said chamber of said housing, and
said casing including at least one first fastening band attached to said upper portion thereof, and at least one second fastening band attached to either of said side portions thereof, for engaging onto the headrest of the vehicle, and for solidly attaching and retaining said carrying case and said electric facility to the headrest of the vehicle.

2. The combination as claimed in claim 1, wherein said housing includes a pocket provided in said lower portion thereof to define a space therein, and to receive a lower portion of said electric facility.

3. The combination as claimed in claim 2, wherein said housing further includes a resilient fastening belt attached to said upper portion thereof, to resiliently clamp an upper portion of said electric facility, and to retain said electric facility in said chamber of said housing.

4. The combination as claimed in claim 1, wherein each of said at least one first fastening band and said at least one second fastening band includes a hook and loop fastening device attached to a free end portion thereof for fastening said carrying case to the headrest of the vehicle.

5. The combination as claimed in claim 1, wherein said casing includes a compartment attached to said outer portion thereof for receiving objects therein.

6. The combination as claimed in claim 1, wherein said casing includes at least one third fastening band attached to said lower portion thereof, and engageable with said at least one first fastening band thereof, to attach said carrying case to the headrest of the vehicle.

7. A combination for attaching to a headrest of a vehicle, said combination comprising:
a carrying case including a housing and a casing each having a side portion secured together, and each having two side portions and an upper portion openably secured together with a fastening device,
said housing and said casing each including a chamber formed in an inner portion thereof for receiving objects, and each including an outer portion superposable with each other,
an electric facility receivable in said chamber of said housing, and
said casing including at least one first fastening band attached to said upper portion thereof, and at least one second and at least one third fastening bands attached to said side portions thereof respectively, for engaging onto the headrest of the vehicle, and for solidly attaching and retaining said carrying case and said electric facility to the headrest of the vehicle.

8. The combination as claimed in claim 7, wherein said housing includes a pocket provided in said lower portion thereof to define a space therein, and to receive a lower portion of said electric facility.

9. The combination as claimed in claim 8, wherein said housing further includes a resilient fastening belt attached to said upper portion thereof, to resiliently clamp an upper portion of said electric facility, and to retain said electric facility in said chamber of said housing.

10. The combination as claimed in claim 7, wherein each of said at least one first and said at least one second and said at least one third fastening bands includes a hook and loop fastening device attached to a free end portion thereof for fastening said carrying case to the headrest of the vehicle.

11. The combination as claimed in claim 7, wherein said casing includes a compartment attached to said outer portion thereof for receiving objects therein.

12. The combination as claimed in claim 7, wherein said casing includes at least one fourth fastening band attached to said lower portion thereof, and engageable with said at least one first fastening band thereof, to attach said carrying case to the headrest of the vehicle.
